(19) United States
(12) Patent Application Publication
(10) Pub. No.: US 2011/0148068 A1
(43) Pub. Date: Jun. 23, 2011

(54) STEERABLE BICYCLE WITH HANDLEBAR PROPULSION

(76) Inventor: Alex Clark Hunt, Maitland, FL (US)

(21) Appl. No.: 12/737,441

(22) PCT Filed: Jun. 5, 2009
(86) PCT No.: PCT/US2009/003433

§ 371 Date: Jan. 7, 2011

Related U.S. Application Data
(60) Provisional application No. 61/191,108, filed on Sep. 6, 2008.

(51) Int. Cl. B62M 1/12; B62M 1/16

(52) U.S. Cl. 280/234

(57) ABSTRACT

A cycle, such as a bicycle, used forward and rearward movement of handlebars to provide an additional force for driving or propelling the rear wheel of a bicycle. A drive rod linkage extends from the handlebars to transmit the fore and aft movement of the handlebars to drive the rear wheel of the bicycle. The rod linkage transfers this fore and aft motion without interfering with conventional steering of the front wheel. Forward and rearward movement of the handlebars is consistent with the normal manner of riding a traditional bicycle.

### BACKGROUND OF THE INVENTION

1. Field of the Invention

This invention is related to a bicycle that can be powered either by the pedal or by back and forth movement of the bicycle handlebars, while the handlebars can also be used to steer the bicycle. Both movements are employed in unison to provide more power to propel the bicycle.

2. Description of the Prior Art

A number of suggestions have been made to employ movement of bicycle handlebars to propel a bicycle, either separate from or in conjunction with standard pedals. These attempts to incorporate arm and body movement with pedaling by the legs do not appear to have resulted in a viable or widely accepted means of propelling a bicycle. It would appear that one possible explanation is that the various prior art approaches do not effectively transmit force or coordinate the movement of the arms and the legs as well as the body, so that a rider can retain his balance and still operate the bicycle in the manner with which he or she has become accustomed.

One approach is to drive the front wheel by moving the handlebars while driving the rear wheel though the pedals. However, this amounts to a two wheel drive mechanism, which is different from a conventional single wheel drive. Turning the bicycle with a driven front wheel would appear to require the rider to adjust his normal technique.

Other suggestions have been made to move the handlebars up and down or to rotate them in a scissor like manner. U.S. Pat. No. 6,688,623 suggests that the opposite ends of handlebars be rotated in a horizontal plane about a central pivot point. None of these movements is similar to the manner in which a rider normally operates and a loss of balance may result or be difficult to learn. Other patents have suggested outrigger style upright handles, which are gripped vertically instead of horizontally. These handlebars could not be operated in a conventional manner as the bicycle must lean to negotiate turns making side to side racking cumbersome at best.

### SUMMARY OF THE INVENTION

The instant invention provides a mechanism for driving a rear wheel on a bicycle by a combination of pedaling and push-pull or back and forth movement of the handlebars. Since it is common for a rider to pull back on the handlebars, especially when straining to provide additional power to climb a hill or grade, this type of handlebar movement is consistent with the normal manner in which most riders have learned to ride a bicycle. In addition to imparting additional force to drive the rear wheels, the instant invention provides a manner of steering the bicycle so that the bicycle can be turned throughout the normal action of the handlebars.

A bicycle or tricycle according to this invention utilizes the push-pull motion of the handlebars, and pedaling to drive the rear wheel or wheels. This machine can be operated in a generally conventional manner, without the need to learn any significantly different technique. The handlebars are moved forward and backward so as to circumscribe an arc back and forth over an imaginary line extending out from, and along the center axis of the front forks attachment to the head tube of the cycle. The bars are pivoted against a fulcrum point that may or may not be located on this axis, however, the feature of the invention is the attachment of the driving rod from the handlebars at a central position of its fore and aft travel upon this heretofore mentioned axis so that the attachment point of this drive rod is not repositioned by steering the cycle.

According to this invention, a bicycle in which forward and rearward motion of handlebars relative to a bicycle frame, as a rider pulls and pushes the handlebars, is transmitted to a rear wheel to impart motion to the bicycle. The bicycle includes a head tube at the front of the bicycle frame about which the handlebars and a bicycle front wheel turn to steer the bicycle. A fulcrum between the handlebars and a front wheel on the bicycle permits forward and backward movement of the handlebars relative to the front wheel and to the bicycle frame. The handlebars rotate through an arc dissected by a head tube axis extending through the head tube so that arcuate movement of the handlebars in front of the head tube axis is equal to arcuate movement of the handlebars behind the head tube axis. A driving rod extends rearwardly from the handlebars. Forward and backward movement imparted to the driving rod by forward and backward movement of the handlebars is transmitted to the rear wheel. A connection between the handlebars and the driving rod permits angular movement of the handlebars relative to the rod to steer the front wheel. The bicycle is propelled by pedaling the rear wheel and by forward and backward movement of the handlebars and pedaling simultaneously applied by a rider.

This cycle, such as a bicycle or a tricycle, is powered by rotation of pedals and by movement of handlebars by a rider imparted by pulling the handlebars back toward the rider and then pushing the handlebars forward away from the rider. The cycle includes a cycle frame, a front wheel steerable by rotation of the handlebars, a rear wheel, and pedals connected to the rear wheel, rotation of the pedals imparting rotation to the rear wheel. A crank is connected to the pedals. A mechanical linkage extends between the handlebars and the crank to transmit movement of the handlebars to the crank. The mechanical linkage is connected to the handlebars permitting the handlebars to be turned to steer the cycle while transmitting force to the mechanical rod linkage.

In other words, a bicycle propelled at least in part by pulling and pushing bicycle handlebars has a fulcrum located between a lever arm connected to the handlebars and a front wheel stem on which a bicycle front wheel is located. The lever arm is rotatable for and aft about the fulcrum relative to the front wheel stem. Both the lever arm and the front wheel stem turn in unison in response to steering movement of the handle bars. A drive rod apparatus extends rearwardly from the handlebars and is connected to the handle bars to move primarily axially rearward when the handlebars are pulled by a rider and primarily axially forward when the handlebars are pushed by a rider. The handlebars being rotate relative to the drive rod to steer the bicycle. A crank is driven in response to forward and rearward movement of the drive rod apparatus. Rotation of the crank applies torque to a bicycle rear wheel to propel the bicycle by pulling and pushing the bicycle handlebars.

### BRIEF DESCRIPTION OF THE DRAWINGS

FIG. 1A is a side view of a bicycle according to this invention that is propelled both by applying force to the pedals and by moving the handlebars back and forth to also drive the rear wheel. FIG. 1B shows the movement of the handlebars and the mechanical linkage in forward, intermediate and rear positions.

FIG. 2 is a top view of the bicycle of FIG. 1 showing the forward and intermediate positions of the handlebars as well as the rotation of the pedals, movement of both the handlebars and the handlebars driving the rear wheel.

FIG. 3 is a view showing the attachment of a rod linkage to the handlebars so that forward and rearward movement of the handlebars will be transmitted through the rod linkage to the rear wheel.

FIG. 4 is a view showing attachment of the rod linkage to a crank driving the sprocketed wheel in combination with the pedals.

FIG. 5 is a view of a double clevis that can be used to attach the rod linkage to the handlebars so that rotation about two mutually perpendicular axes is possible so that the handlebars can be moved to steer the bicycle while also being rocked to drive the rod linkage.

FIG. 6 is a view of a second clevis that attached a front rod to a rear rod so that the rods can rotate relative to each other during axial movement of the rods.

FIGS. 7A-7D are views of an idler member that can be attached to the bicycle frame to support the rear rod. FIGS. 7C and 7D show the entire idler assembly comprised of two rollers shown in FIG. 7B mounted on two bars shown in FIG. 7A.

FIG. 8 is a view of a second embodiment of a bicycle including a trapezium located between the handlebars and the front wheel so that movement of the handlebars is leveled to a certain degree and while the full displacement of the crank is deployed to do work.

FIG. 9 is a view of the trapezium shown in FIG. 7 showing the manner of connecting a front rod in the mechanical rod linkage to the trapezium and the location of the fulcrum between the front wheel and the trapezium.

FIG. 10 is a schematic of an alternate embodiment in which the rod linkage is attached to a hinged bushing that is mounted on a vertical stem to permit rotation, about two mutually perpendicular axis, of handlebars about the stem axis and simultaneously rocking of the handlebars as the handlebars are moved between forward and rearward positions to drive the rod linkage.

FIG. 11 is a view of another alternate embodiment in which a driving sprocketed wheel mounted on the bicycle frame is driven by movement of the handlebars and a chain extending from this driving sprocketed wheel to the main sprocketed wheel transfers force to the rear wheel.

FIG. 12 is a view of an alternate embodiment of a bicycle having a trapezium mounted on the handle with a drive rod turning a crank adjacent the main sprocket.

FIG. 13 is a view of another alternate embodiment including a linkage that allows more fore and after movement of the handlebars.

FIG. 14 is a view of a tandem bicycle incorporating this invention.

### DETAILED DESCRIPTION OF THE PREFERRED EMBODIMENTS

The bicycle 2, which comprises the preferred representative embodiment of this invention, is powered both by pedaling the bicycle in conventional fashion, and also by pushing and pulling the bicycle handlebars 4 to impart an additional force to the bicycle rear wheel 8. A rider will tend to push and pull the handlebars 4 even when normally pedaling a bicycle 2, and especially when the rider is attempting to climb a hill. Thus the tendency to push and pull the handlebars 4 is natural and can be well coordinated with pedaling action. With this invention, this push-pull action will cause the handlebars 4 to move back and forth, and this back and forth motion will generate a force or torque that can be transmitted to the rear wheel 8. In addition to being used to propel the bicycle 2, the handlebars 4 will also steer the bicycle 2 by rotating the front wheel 6 in the same proportion as with a conventional bicycle. Therefore the additional power available with bicycle 2 is developed without requiring the rider to significantly alter the normal manner of riding a conventional bicycle and will allow the rider to consistently maintain his or her balance in the manner with which he or she has become accustomed.

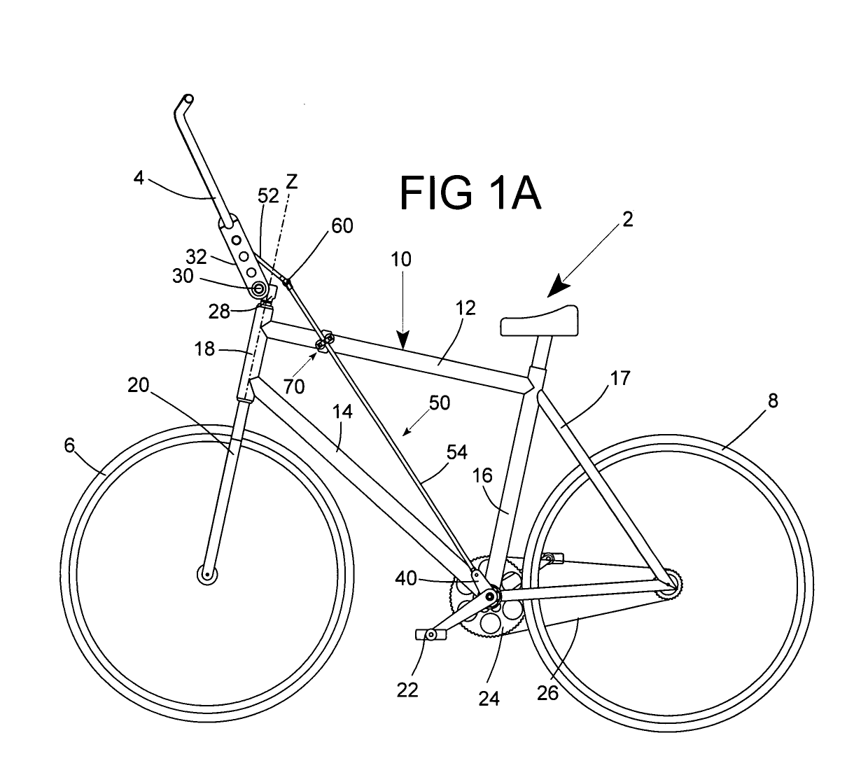

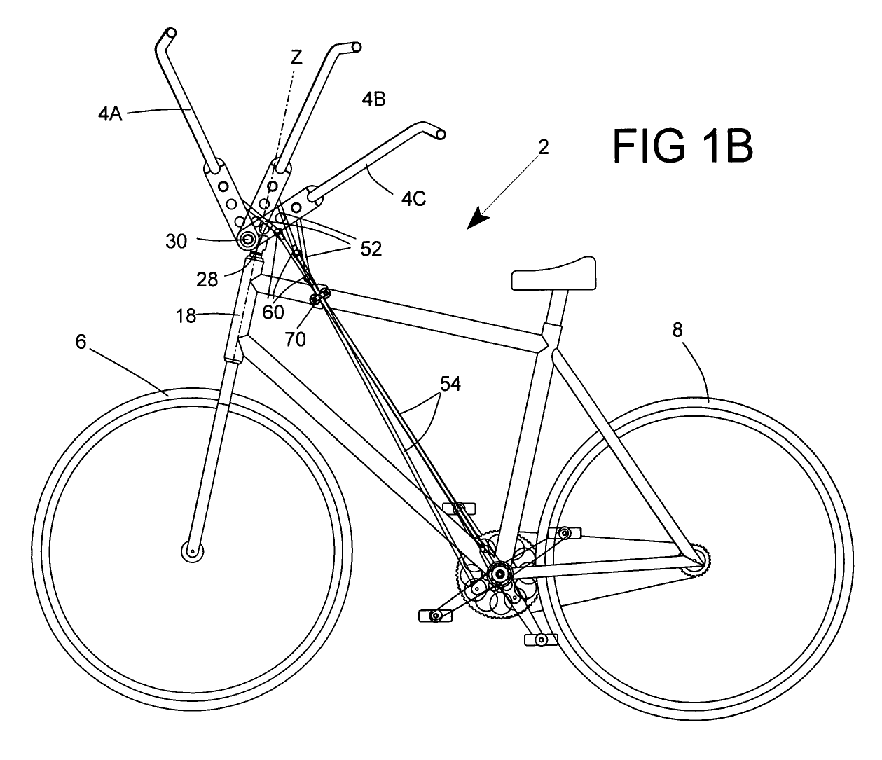

As depicted in the first representative embodiment of FIG. 1, the bicycle 2 includes a bicycle frame 10 comprising a triangular frame including a top tube horizontal frame member 12 and a down frame member 14 extending from a head tube 18 to a bottom bracket shell, which contains bearings for the pedals 22. A seat frame tube 16 extends between the bottom bracket and the seat. A rear frame triangle 17 extends between the axle of the rear wheel 8 and the intersection of the frame members 12 and 16 below the seat and through the rear drop outs from the rear axle back to the bottom bracket.

The front wheel 6 is mounted on the frame 10 by a fork 20 in the same manner as in a conventional bicycle. However, a front wheel stem, which extends through head tube 18, and is concentric with head tube 18, is connected to the handlebars 4 about a point 28 on the axis Z of the front wheel stem (which coincides with the axis of the head tube 18) at a the top of the front wheel stem. The point 28 remains fixed, while the handlebars rotate for steering and while the handlebars 4 rotate to drive the rear wheel 8. This fulcrum is slightly spaced from the point 28 at the top of the front wheel stem. The handlebars will rotate about the fulcrum 30 as the rider pushes and pulls on the handlebars 4 to respectively produce forward movement of the handlebars 4 relative to the front wheel 6 and rearward movement. The handlebars 4 will also move back and forth relative to the bicycle frame 10 about the attachment point 28. The handlebars 4 will rotate about the fulcrum 30 as they move between the front and rear positions, the center of such pivoting being on the head tube axis Z. Rocking or rotation of the handlebars 4 is shown in FIG. 1B, where the position of the handlebars in the forward position is shown as 4A, an intermediate handlebar position being indicate as 4B, and a rear position being shown as 4C. The handlebars 4 rotate through an equal arc in front of the head tube axis Z and behind the head tube axis Z, as the pedals 22 rotate through a complete three hundred and sixty degree cycle.

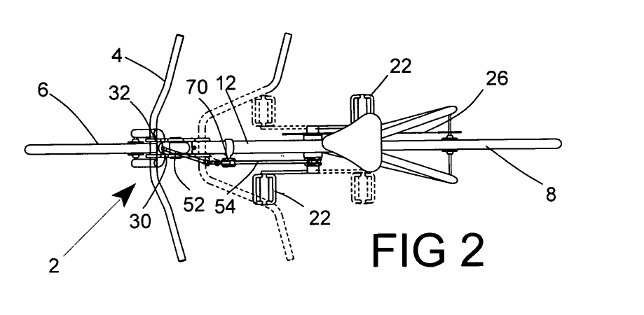

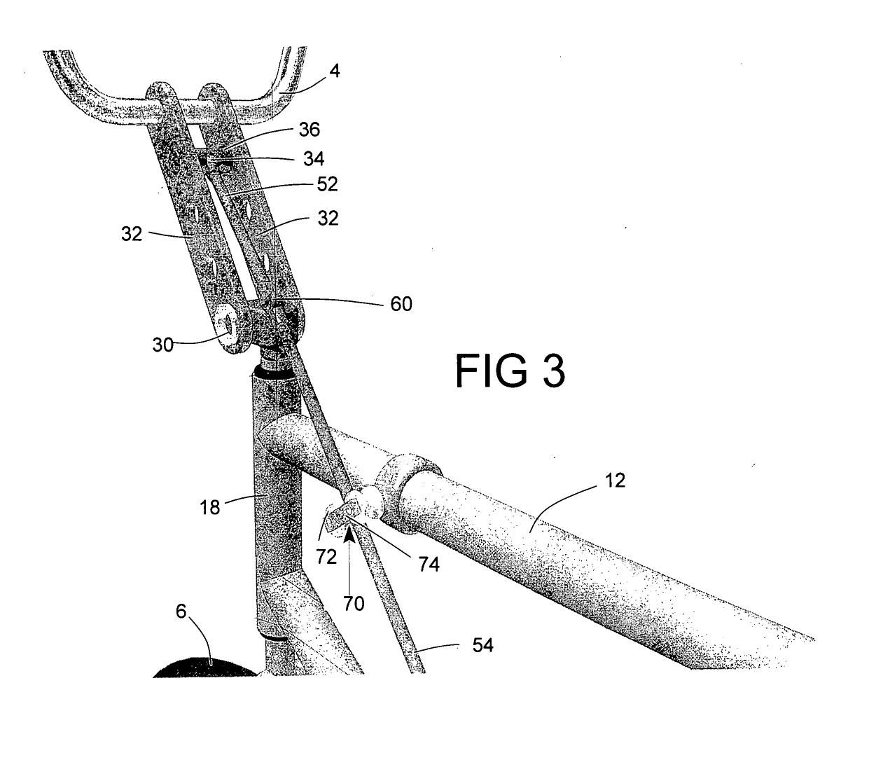

Lever arms or rails 32 extend from the fulcrum 30 to the handlebars 4, as shown in FIGS. 1-3. A mechanical rod linkage 50 is attached to the handlebars 4 at rod 36 in the vicinity of the attachment of the lever arms 32 and the handlebars 4 so that lever arm 32 transmits an axial force, either in compression or in tension to the mechanical rod linkage 50 as the handlebars 4 are moved back and forth. In the embodiment shown in FIGS. 1-4, the mechanical rod linkage 50 includes a front rod 52 connected to a rear rod 54 by a pivoting joint 60, such as a clevis employed in this embodiment. The clevis joint 60 permits angular movement between front rod 52 and rear rod 54, which occurs as the mechanical rod linkage 50 moves back and forth in response to back and forth movement of handlebars 4.

The front rod 52 is connected to the handlebars 4 by a double clevis connection 34, shown in more detail in FIG. 5. A ball and socket joint, or a universal joint, or a clevis joined to a bearing or any other connection that permits the handlebars to rotate about two mutually transverse, and generally perpendicular, axes relative to the front rod 52 of the mechanical rod linkage 50 can be substituted for the double clevis connection 34. This double clevis joint 34 must also be capable of transmitting forward and rearward movement to front rod 52 no matter what angle the handlebars 4 are turned relative to rod 52 and the bicycle frame 10 as the handlebars 4 steer the bicycle 4 around turns. The double clevis 34 permits rod 52 to rotate about two mutually transverse, and generally perpendicular, axes demonstrated by axis Y-Y in FIG. 5 and by the arrows showing rotation about an axis perpendicular to the view shown in FIG. 5. Even when the front wheel 4 is turned, the handlebars 4 can still be moved back and forth over the center of the front fork or head tube axis Z and relative to fulcrum or pivot point 30 to apply force to front rod 52. It should be understood that an alternate version of a double clevis joint would permit the rod 36 to rotate relative to the rails or lever arms 32, with a clevis joint attached to the front end of rod 52 to permit rotation about a second axis.

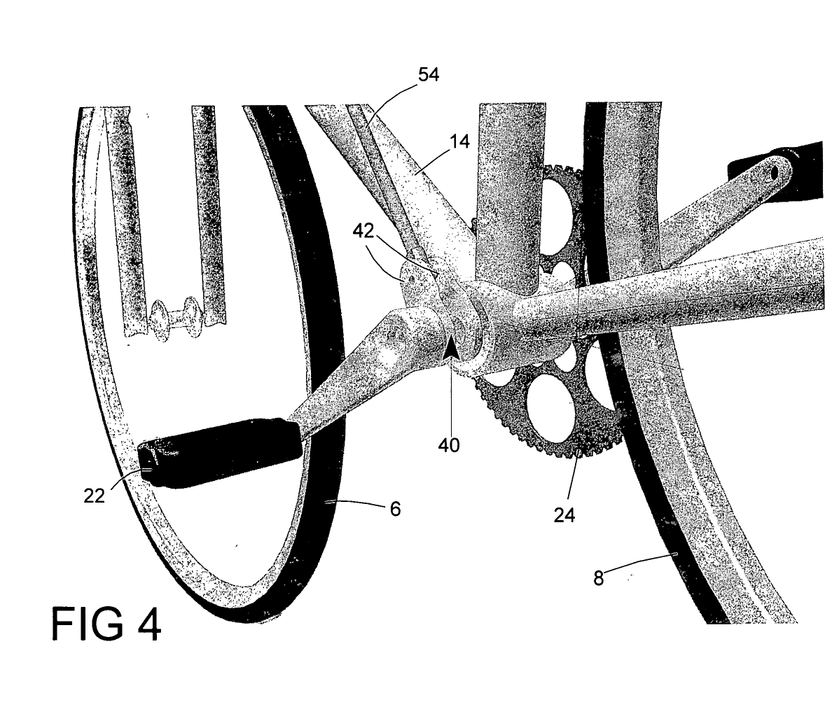

The rear rod 54 of mechanical linkage 50 is attached to a crank 40 located between pedals 22, mounted on a bottom bracket shell, as shown in FIG. 4. This crank 40 comprises two crank arms 42 attached to rear rod 54 and located between the two crank arms 42. The opposite ends of the crank arm 42 are mounted on the axle extending though the bottom bracket shell on which the pedals 22 are mounted so that crank 40 will drive the sprocketed wheel 24 and the chain 26 to impart rotation to the rear wheel 8. The force transmitted by the crank 40, in response to movement of the handlebars 4, will be in addition to the force applied through the pedals 14. As the crank arms 42 rotate, the rear rod 54 will move laterally of its axis in addition to the axial movement. The rear rod 54 will twist and deflect as the bicycle is steered, and the rear rod can be connected to the crank 40 by a hinge to permit such twisting.

Clevis 60 comprises first clevis yoke 62 and a clevis pin 64. Clevis 60 also includes a hinged joint 66 that allows clevis to rotate about an axis generally perpendicular to the axis of about which the rod 54 will rotate relative to the clevis 60. A universal joint or a ball and socket joint could also be employed. The front rod 52 is joined to the clevis yoke 62 by a connection that is not bottomed out and will allow an axial rotation between rod 52 and clevis 60. The clevis pin 64 is mounted on the rear rod 54 so that the rear rod can rotate relative to the front rod about clevis joint 60 about an axis extending transverse to both the front rod 52 and the rear rod 54. Both rods 52 and 54 can twist in unison about their axes, and this twisting motion is transmitted through the clevis joint 60.

Although the rear rod 54 move laterally, this movement is redirected and restrained by an idler 70 attached to the horizontal frame 12 adjacent to the clevis 60. Idler 70 comprises two rollers 72, each having concave surfaces capturing the cylindrical rear rod 54. These rollers 72 are mounted on pivoting bars 74 located on opposite ends of the rollers 72, which are free to rotate relative to the bars 74. Bars 74 are in turn mounted to pivot relative to frame arm 12 so that as the rear rod 54 moves laterally of its axis, the rollers 72 are free to rotate and the pivoting bars 74 are also free to rotate. Thus idler 70 will stabilize the rod 54, but will still allow movement so that the rod 54 does not bind as it is pushed and pulled, back and force to impart rotation to crank 60 while remaining sturdily attached to the bicycle frame.

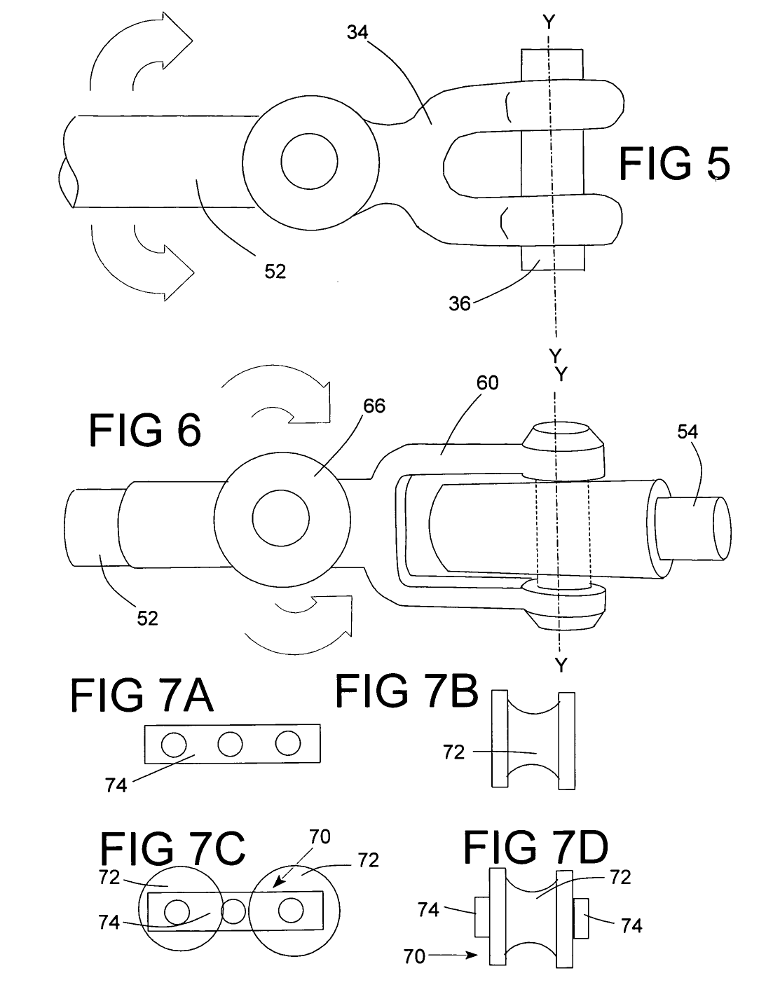

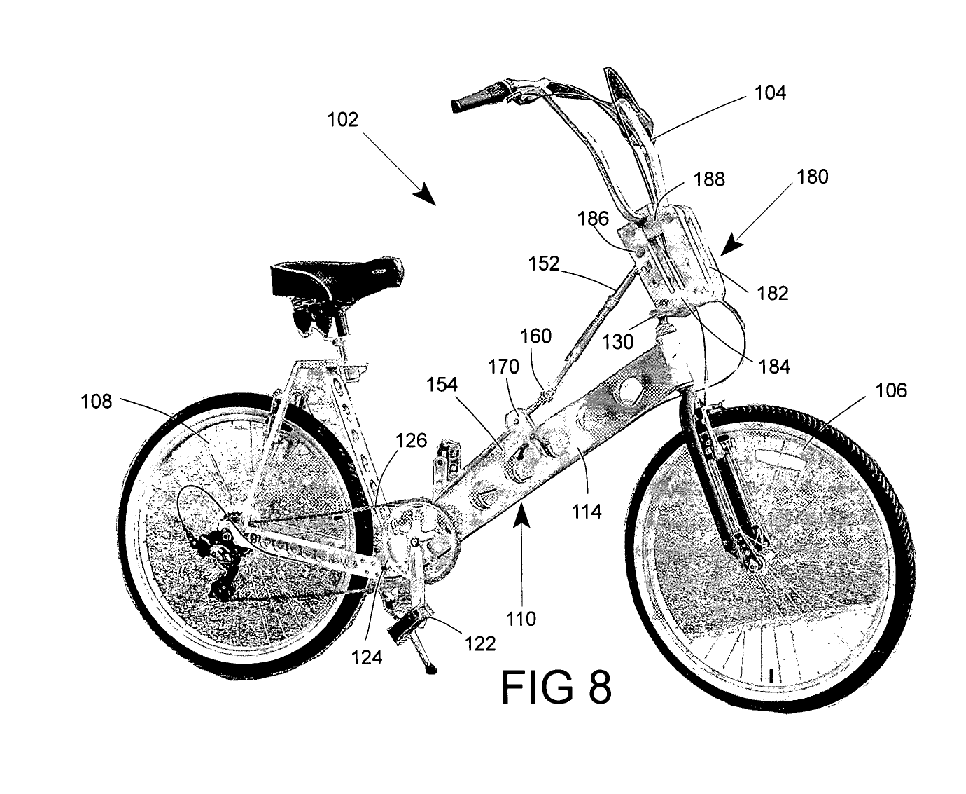

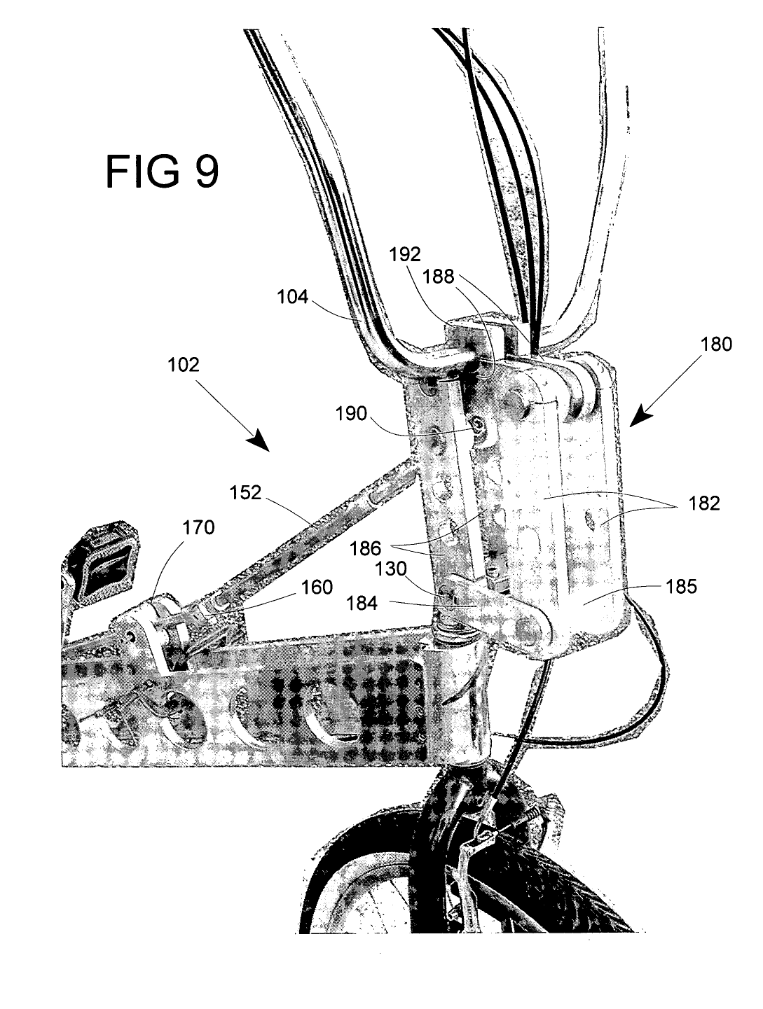

FIGS. 8 and 9 show a second embodiment of a bicycle 102 that also uses a mechanical rod linkage to transmit a force due to back and forth movement of handlebars 104 to a rear wheel 108. This bicycle employs a trapezium 180 to limit the amount of elevation change in the handlebars 104 during back and forth movement. Effectively the trapezium 180 levels the movement of the handlebars 104 so that they can be pushed and pulled more easily by the rider. The trapezium is mounted between the handlebars 104 and the fulcrum 130 located just above the front wheel 106. The trapezium 180 not only provides lever arms, as lever arms 32 in the embodiment of FIGS. 1-6, but also provides the leveling function. Trapezium 160 comprises a bar linkage including two pairs of four bars 182, 184, 186, and 188 hinged about pins, such as pin 185, located at the ends of each of the four bars. The pairs of bars are spaced apart by a distance that will allow front rod 152 to be connected between the two rear bars 186. The handlebars 104 are attached to the top trapezium bars 188 by mounting members 192. The rod 152 will then move with the rear bars 186 and the handlebars will move with the top bars 188.

Rod 152 is connected to rod 154 by a clevis 160 in much the same manner as in the first embodiment, and rod 154 will drive a crank, not shown, located between pedal 122. The rods 153 and 154 will drive the sprocket 124 and the chain 126 to drive rear wheel 108. This embodiment does not employ an upper horizontal frame member, and the rear rod 154 is stabilized by idler 170 mounted on the lower frame member 114. The angle between rods 152 and 154 is therefore greater than for the earlier embodiment, but the rods 152 and 154 are spaced further from the mid section of the bicycle providing improved clearance for the rider.

The trapezium 180 will tend to cause the handlebars 104 to move in a more level orientation because the bars 188 to which the handlebars 104 are attached will tend to move parallel to the ground. As the handlebars 104 are pulled back from the position shown in FIGS. 8 and 9, the bars will rotate about the pins at each corner so that the pin 185 will move in an opposite direction to the pin at the upper left corner as shown in FIG. 9. The angle between bars 182 and 184 will tend to decrease, while the angle between bars 184 and 186 will become greater. The same thing happens at diagonally opposed corners. As the bars move in this direction, the upper bars 188 will tend to remain level, and therefore the handlebars 104 attached to bars 188 will also tend to remain somewhat level, or at least not to move as far down on an arcuate path, as with the handlebars 4 in the first embodiment. The trapezium 180 will also rotate with handlebars 104 when the bicycle is turned, and the rod 152 will be joined to trapezium 180 by a ball and socket joint or other joints that will allow rotation of the handlebars relative to rod 152 and to the frame 110. The rod 152 is also attached to clevis 160 so that rod 152 can twist about its longitudinal axis to prevent the rods 152 and 154 to bind during movement of the handlebars 104.

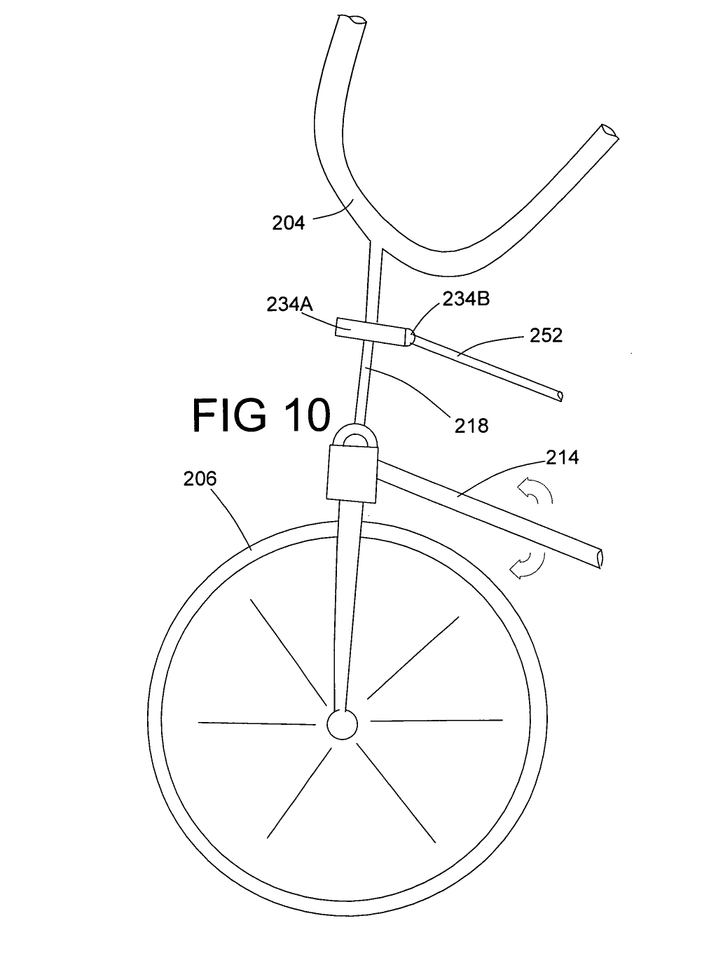

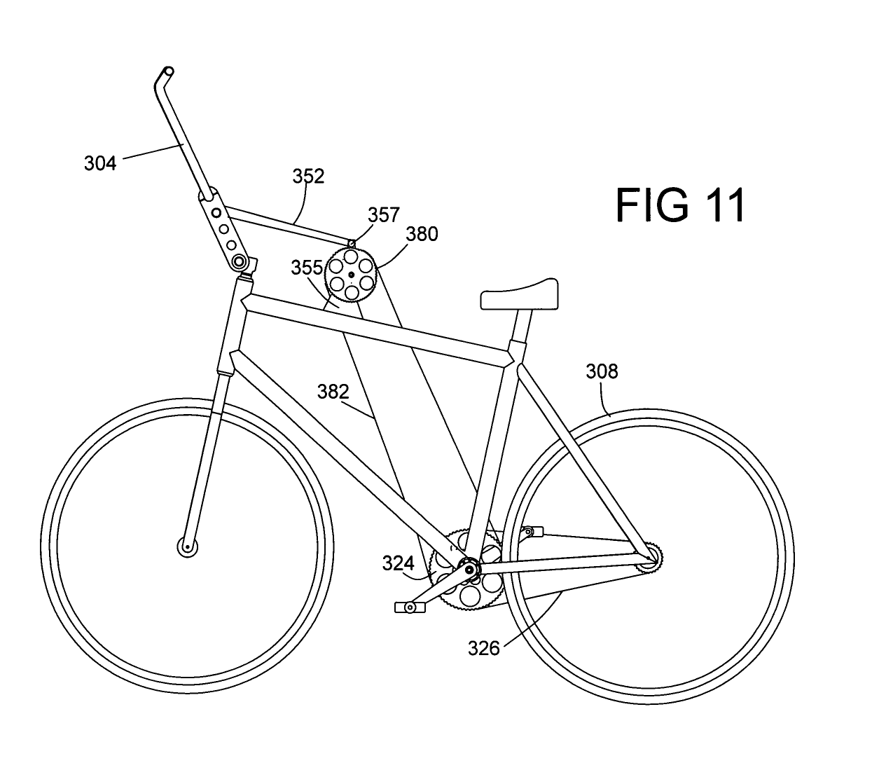

FIG. 10 shows another embodiment of a linkage that permits coordinated push-pull movement of the handlebars 204 to drive the rear wheels while the bicycle can be turned by the handlebars in a conventional manner. Here the handlebars 204 are connected to the front wheel 206 by a swivel including a bearing 234A rotatable around the front forkshaft or stem 218, which permits the handlebars 204 to be turned. A hinge 234B attached to the outer shell of bearing 234A allows the handlebars 204 to tilt and drive a rod 252, which can be connected to a crank arm (not shown). This is possible because of a power transfer linkage from the handlebars through the bearing 234A on the handlebar shaft through a hinge connection 234B, which connects to a bearing 234A, which allows the tilting of the handlebar pivoted on a clevis 230 at the point of zero travel which in this example is centered on top of the bicycle fork, which is attached to the bicycle frame 214. This linkage allows steering of the bicycle while tilting the handlebars to propel the bicycle. A two bar rod linkage of the same type employed in the first embodiment can be employed with this version

Another embodiment is shown in FIG. 11. In the embodiment of FIG. 9, a driving rod 352, driven by forward and rearward movement of the handlebars 304, is connected at the driving rod rear end to an arm 357, which imparts rotation to a driving sprocketed wheel 380. The sprocketed wheel 380 is mounted on the bicycle frame by a support 355. A chain 382, extending between the driving socket and a driven socket 324 transfers torque developed by movement of the handlebars 304 between forward and rear positions, to in turn drive the chain 326, and the rear wheel 308.

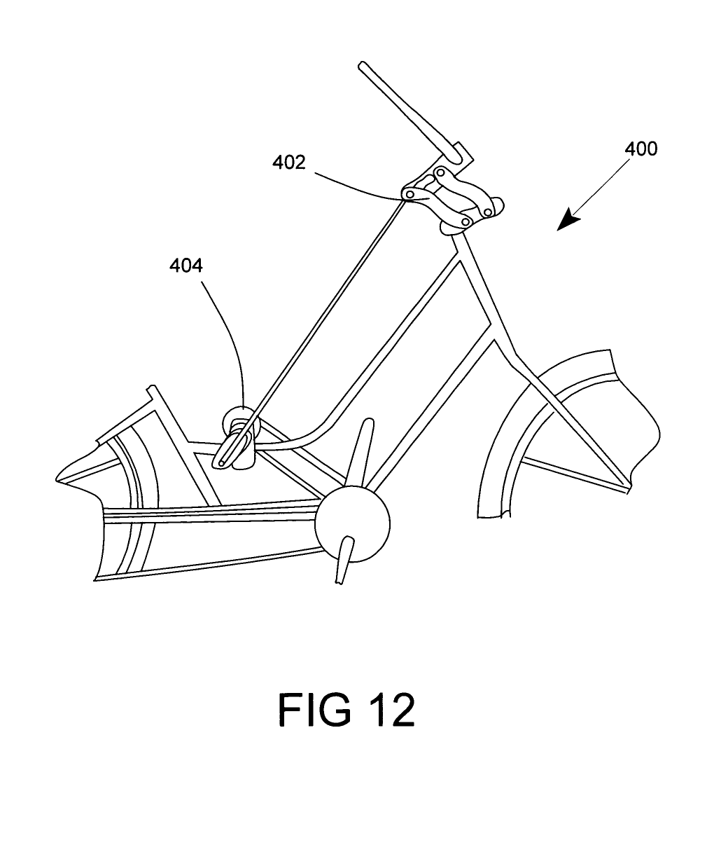

FIG. 12 shows an alternate embodiment of bicycle 400 that can be powered by moving the handlebars as well as by pedals. Bicycle 400 includes a trapezium 402 mounted on the handlebars for providing level movement of the handlebars when they are pulled and pushed to impart force to the rear wheels. The trapezium 402 is mounted between the handlebars and a rod extending to a crank 404 mounted on the bicycle frame near the pedals. The rod imparts rotation to the crank 404 in response to pulling and pushing the handlebars. The crank 404 is attached to the main sprocket, driven by the pedals, by a chain.

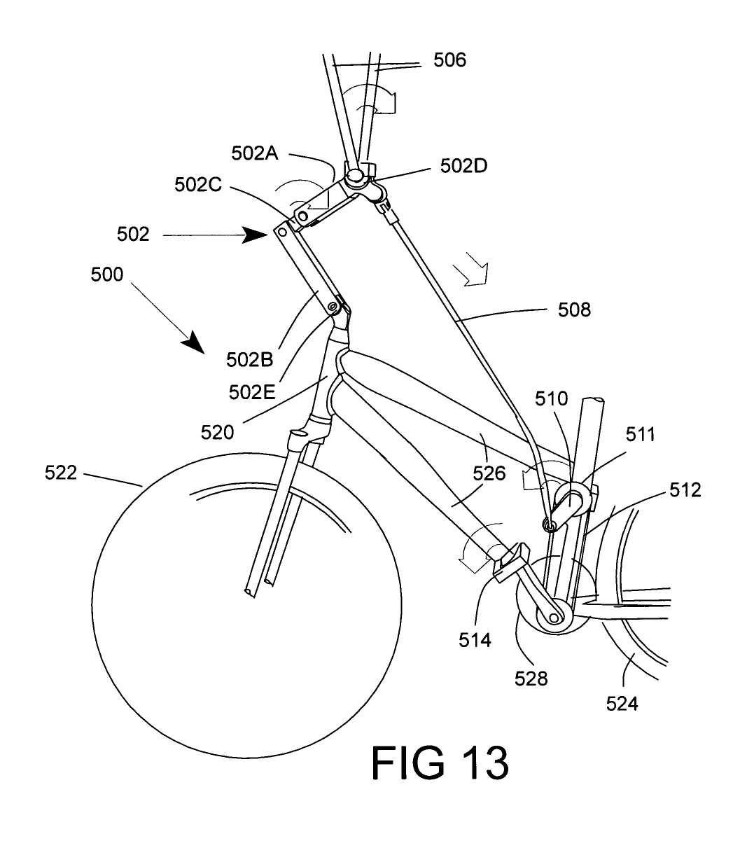

FIG. 13 shows another alternate embodiment of a bicycle 500 in which backwards and forwards movement of the handlebars 506 drives a rod 508, which in turn drives the rear wheel 524 to propel the bicycle together with the propulsion force applied through the pedals 514. In this embodiment, the handlebars 506 are connected to a linkage 502 that extends in front or forward of the head tube, steering column or crown 520 connected to the bicycle frame 526. The linkage 502 comprises an upper arm 502A pivotally connected by an intermediate link 502C to a lower arm 502B. The intermediate link 502C is pivotally connected to both the upper arm 502A and the lower arm 502B, so that upper arm 502A can pivot or rotate relative to lower arm 502B. The upper arm 502A is connected to the handlebars 506 though a pivotal joint 502D, and the rod 508 is also connected to the pivotal joint 502D. The joint 502D comprises a double swivel attachment, which allow both rotational and lateral motion as the handlebars are pulled back and forth and/or turned to steer the bicycle. The lower arm 502B is connected to a steering tube that extends through the head tube, steering column or crown 520 and rotation of the handlebars rotates this steering tube relative to the crown 520 to turn front wheel 522. The joint 502E does not allow the lower arm 502B to move, but the angle of the steering rod can be changed for handlebar height adjustment and the position of joint 502E moves relative to the crown 520 as the height is adjusted. The linkage 502 thus extends between the handlebars 506 and the steering mechanism, and pivotal movement of the upper arm 502A relative to lower arm 502B does not interfere with steering the bicycle by turning the handlebars 506 while the handlebars 506 move back and forth to drive the rear wheel 524. In other words the position of the joint 502D remains centered substantially above the center axis of the crown 520 as the handlebars 506 are moved fore and aft.

Movement of the rod 508 in response to back and forth movement of the handlebars 506 will drive crank 510. Crank 510 is connected to a drive sprocket 511 and chain 512 drives the main sprocket 528. Since the pedals 514 also drive the main sprocket 528, the force applied by moving the handlebars 506 with the body and arms is added to the force applied to the pedals by the legs.

The arrows in FIG. 13 show the movement of the various components when the handlebars 506 are pulled back toward the rider. The linkage 502 extends in front of the handlebars 506 and the steering column 520. Pivotal movement of this linkage thus increases the amount of movement of the handlebars 506 without movement of the handlebars so close to the rider that it would restrict normal movement of the arms or tend to throw the rider off balance. This freedom of movement is accomplished without interfering with steering.

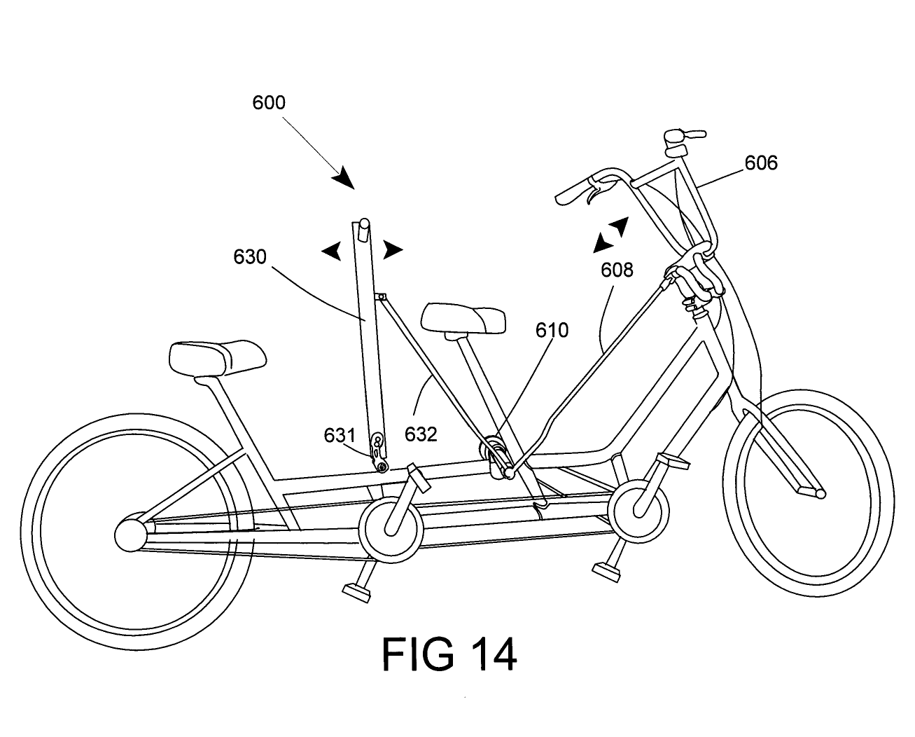

FIG. 14 shows that the basic mechanism depicted in the other embodiments can be applied to a tandem bicycle 600 for two riders. The rider in the front pulls the handlebars 606 in the same manner as previously discussed while he pedals, and as indicated by the arrowheads. The rider in the rear pedals in the same manner that the rear rider would pedal in a conventional tandem bicycle. The rear rider can also pull and push on the T-handle post 630, which is hinged at its base by a hinge 631 also attached to the frame, so that both riders can apply force through their arms and their legs. The handlebars 606 are attached to a drive crank 610 by rod 608. A rear rod 632 extends between the post 630 and the drive crank 610. The post 630 will move in unison with the handlebars 606.

Although each of the preferred embodiments of this invention comprise a bicycle, it should be understood that the same mechanism can be applied to a tricycle or other cycles having front and rear wheels.

The representative embodiments depicted herein do not comprise the only configurations employing the invention disclosed herein. Other alternatives would be apparent to those of ordinary skill in the art. The invention is therefore not limited to these representative embodiments, but is instead defined by the following claims.

I claim:

1. A bicycle in which forward and rearward motion of handlebars relative to a bicycle frame, as a rider pulls and pushes the handlebars, is transmitted to a rear wheel to impart motion to the bicycle, the bicycle comprising:
a head tube at the front of the bicycle frame about which the handlebars and a bicycle front wheel turn to steer the bicycle;
a fulcrum between the handlebars and a front wheel on the bicycle, the fulcrum permitting forward and backward movement of the handlebars relative to the front wheel and to the bicycle frame, the handlebars rotating through an arc dissected by a head tube axis extending through the head tube so that arcuate movement of the handlebars in front of the head tube axis is equal to arcuate movement of the handlebars behind the head tube axis;
a driving rod extending rearwardly from the handlebars, forward and backward movement imparted to the driving rod by forward and backward movement of the handlebars being transmitted to the rear wheel;
a connection between the handlebars and the driving rod permitting angular movement of the handlebars relative to the rod to steer the front wheel;
the bicycle being propelled by pedaling the rear wheel and by forward and backward movement of the handlebars and pedaling simultaneously applied by a rider.

2. The bicycle of claim 1 wherein the driving rod is connected to the handlebars so the driving rod is rotatable relative to the handlebars about two mutually perpendicular axes.

3. The bicycle of claim 1 wherein the driving rod is connected to the handlebars by a double clevis.

4. The bicycle of claim 1 wherein the driving rod comprises a first rod connected to a second rod by a flexible joint to allow mutual rotation between the first and second rods as the first and second rods move back and forth in response to back and forth movement of the handlebars.

5. The bicycle of claim 4 wherein the flexible joint transmits axial loads from the first rod to the second rod.

6. The bicycle of claim 4 wherein the second rod is connected to a crank located between bicycle pedals.

7. The bicycle of claim 1 wherein the driving rod is connected to the handlebars so that the connection between the handlebars and the driving rod remains aligned with an axis about which the handlebars rotate to turn the front wheel to steer the bicycle so that the driving rod does not restrict the turning action of the handlebars.

8. The bicycle of claim 1 wherein the driving rod is connected by a hinge to a rotatable bushing located above the fulcrum so that the rod is rotatable relative to the bushing and the bushing is rotatable relative a stem extending upwardly from the fulcrum.

9. The bicycle of claim 1 wherein the driving rod is connected to a driving sprocketed wheel located on the bicycle frame behind the handlebars so that forward and rearward movement of the handlebars causes rotation to the driving sprocketed wheel, with a chain attached to a driven sprocketed wheel imparting rotation to the driven sprocketed wheel, which in turn drives the bicycle rear wheel.

10. A cycle powered by rotation of pedals and by movement of handlebars by a rider imparted by pulling the handlebars back toward the rider and then pushing the handlebars forward away from the rider, the cycle comprising:
a cycle frame;
a front wheel steerable by rotation of the handlebars;
a rear wheel
pedals connected to the rear wheel, rotation of the pedals imparting rotation to the rear wheel;
a crank connected to the pedals;
a mechanical linkage extending between the handlebars and the crank to transmit movement of the handlebars to the crank;
wherein the mechanical linkage is connected to the handlebars by connecting means permitting the handlebars to be turned to steer the cycle while transmitting force to the mechanical rod linkage.

11. The cycle of claim 10 wherein the cycle comprises a bicycle.

12. The bicycle of claim 11 wherein the mechanical linkage comprises two rods joined intermediate the ends of the mechanical linkage by a clevis joint.

13. The bicycle of claim 12 wherein movement of one of the two rods laterally of its axis is limited relative to the bicycle frame.

14. The bicycle of claim 11 wherein the connecting means connecting the mechanical linkage to the handlebars includes a double clevis.

15. The bicycle of claim 11 wherein the connecting means connecting the mechanical linkage to the handlebars permits rotation of the handlebars relative to the mechanical linkage about two mutually perpendicular axes.

16. A bicycle propelled at least in part by pulling and pushing bicycle handlebars, the bicycle comprising:
a fulcrum located between a lever arm connected to the handlebars and a front wheel stem on which a bicycle front wheel is located, the lever arm being rotatable for and aft about the fulcrum relative to the front wheel stem, both the lever arm and the front wheel stem turning in unison in response to steering movement of the handle bars;
a drive rod apparatus extending rearwardly from the handlebars and connected to the handle bars to move primarily axially rearward when the handlebars are pulled by a rider and primarily axially forward when the handlebars are pushed by a rider, the handlebars being rotatable relative to the drive rod to steer the bicycle; and
a crank driven in response to forward and rearward movement of the drive rod apparatus, rotation of the crank applying torque to a bicycle rear wheel to propel the bicycle by pulling and pushing the bicycle handlebars.

17. The bicycle of claim 16 wherein the lever arm comprises a pair of side by side rails extending between the fulcrum and the handlebars and located on opposite sides of the drive rod apparatus.

18. The bicycle of claim 16 wherein the drive rod apparatus is connected to the handlebars along an extended axis of a fork turning tube, about which the front wheel stem rotates, when the handlebars are at a mid-point between maximum forward travel and maximum rearward travel as the handlebars are pushed and pulled.

19. The bicycle of claim 16 wherein the handlebars move from maximum forward travel to maximum rearward travel and back to maximum forward travel, the pedals rotate through a complete cycle.

20. The bicycle of claim 16 wherein the drive rod apparatus is connected to the lever arm by a double clevis permitting rotation of the drive rod apparatus, relative to the lever arm about two mutually perpendicular axes.
